(19) United States
(12) Patent Application Publication
(10) Pub. No.: US 2024/0117507 A1
(43) Pub. Date: Apr. 11, 2024

(54) WATER ELECTROLYSIS

(71) Applicant: Triad National Security, LLC, Los Alamos, NM (US)

(72) Inventors: Dongguo Li, Los Alamos, NM (US); Yu Seung Kim, Los Alamos, NM (US); Albert Sung Soo Lee, Los Alamos, NM (US)

(21) Appl. No.: 18/384,737

(22) Filed: Oct. 27, 2023

Related U.S. Application Data
(63) Continuation of application No. 17/025,493, filed on Sep. 18, 2020, now abandoned.
(60) Provisional application No. 62/903,299, filed on Sep. 20, 2019.

(51) Int. Cl. C25B 9/23; B01D 67/00; B01J 39/04; B01J 39/20; C25B 1/04; C25B 9/73; C25B 11/04; C25B 13/04

(52) U.S. Cl. CPC C25B 9/23; B01D 67/00931; B01J 39/04; B01J 39/20; C25B 1/04; C25B 9/73; C25B 11/04; C25B 13/04

(57) ABSTRACT

Water electrolysis systems that operate at intermediate temperature (i.e., between about 100° C. and about 300° C.) are described. At least some aspects of the present disclosure relate to proton exchange membrane steam electrolysis (PEMSE) systems including a polymer electrolyte comprising at least one phosphorus atom. In at some examples, the polymer electrolyte my comprise phosphonic acid.

This application is a continuation of U.S. application Ser. No. 17/025,493, filed Sep. 18, 2020, which in turn claims the benefit of U.S. Provisional Patent Application No. 62/903,299, filed on Sep. 20, 2019, both of which are incorporated by reference herein in their entirety.

### STATEMENT REGARDING FEDERALLY SPONSORED RESEARCH OR DEVELOPMENT

The United States government has rights in this invention pursuant to Contract No. 89233218CNA000001 between the United States Department of Energy (DOE), the National Nuclear Security Administration (NNSA), and Triad National Security, LLC for the operation of Los Alamos National Laboratory.

### BACKGROUND

Hydrogen, produced by water electrolysis, serves as a carrier to store energy from intermittent renewable power sources without a carbon footprint. This has been reflected by the H₂@scale initiative led by the Department of Energy's Hydrogen and Fuel Cell Technologies Office (HFTO). The prohibitive feedstock cost restricts the wide application of water electrolysis, compared to much less expensive methane reforming. Despite that, the coupling of water electrolysis with off-peak renewable energy (e.g., wind or solar) offers some new opportunities. However, electrical efficiency is a barrier to economic viability. To this end, electrolysis at elevated temperature can offer the advantage of lower energy requirements due to both enhanced kinetics and lower equilibrium voltage.

Low-temperature (e.g., <100° C.) proton exchange membrane water electrolysis (PEMWE) produces hydrogen with moderate efficiency [about 75%, from high heat value (HHV)]. High-temperature solid oxide electrolysis (SOE) operates at >600° C. to generate hydrogen with high efficiency (>100%, HHV). However, commercialization of SOE has been limited due to the restriction on the materials that can be used. Additionally, the extremely high temperatures greatly limit the ability to on/off cycle or follow intermittent loads, making this technology a poor choice for coupling with renewable sources.

### SUMMARY

An aspect of the present disclosure relates to a proton exchange membrane steam electrolysis (PEMSE) system including an anode, a cathode, and a polymer electrolyte located between the anode and the cathode, with the polymer electrolyte being configured to operate between about 100° C. and about 300° C., and the polymer electrolyte including a repeating plurality of styrene monomers. In at least some embodiments, the plurality of styrene monomers includes a styrene monomer including benzene functionalized with fluorine at all carbons except a para-carbon and a carbon attached to a backbone of the styrene monomer. In at least some embodiments, the para-carbon is functionalized with phosphonic acid. In at least some embodiments, the plurality of styrene monomers includes a styrene monomer including benzene functionalized with fluorine at all carbons except a carbon attached to a backbone of the styrene monomer.

Another aspect of the present disclosure relates to a PEMSE system including an anode, a cathode, and a polymer electrolyte located between the anode and the cathode, with the polymer electrolyte configured to operate between about 100° C. and about 300° C. In at least some embodiments, a side chain of the polymer electrolyte includes at least one aromatic molecule. In at least some embodiments, the at least one aromatic molecule is functionalized with at least one halogen atom. In at least some embodiments, the at least one halogen atom is fluorine. In at least some embodiments, the at least one aromatic molecule is functionalized with halogen atoms at ortho and meta carbons. In at least some embodiments, the polymer electrolyte includes a backbone including at least one aromatic organic molecule. In at least some embodiments, the at least one aromatic organic molecule includes at least one of biphenyl, para-terphenyl, ortho-terphenyl, or fluorene. In at least some embodiments, the polymer electrolyte includes a side chain including nitrogen. In at least some embodiments, the side chain is doped with an acid. In at least some embodiments, the acid is either phosphonic acid or phosphoric acid. In at least some embodiments, the phosphonic acid includes at least one halogen atom. In at least some embodiments, the polymer electrolyte includes a polyaromatic ammonium polymer doped with phosphoric acid. In at least some embodiments, the polymer electrolyte includes a polyaromatic ammonium polymer doped with phosphonic acid.

A further aspect of the present disclosure relates to a method of making a PEMSE system, the method including providing an anode, providing a cathode, providing a polymer electrolyte, and positioning the polymer electrolyte between the anode and the cathode, with the polymer electrolyte being configured to operate between about 100° C. and about 300° C. In at least some embodiments, providing the polymer electrolyte includes providing a polyaromatic fluorinated phosphonic acid polymer. In at least some embodiments, providing the polymer electrolyte includes providing the polymer electrolyte with a side chain including at least one aromatic molecule functionalized with at least one halogen atom.

### BRIEF DESCRIPTION OF DRAWINGS

For a more complete understanding of the present disclosure, reference is now made to the following description taken in conjunction with the accompanying drawings.

FIG. 1 is a conceptual diagram of a proton exchange membrane steam electrolysis (PEMSE) system, in accordance with embodiments of the present disclosure.

FIG. 2 illustrates possible backbone structures for a phosphonated aromatic proton exchange membrane (PEM), in accordance with embodiments of the present disclosure.

FIG. 3A illustrates an example polymer electrolyte including an ammonium-biphosphate (phosphoric acid) ion-pair coordinated side chain, in accordance with embodiments of the present disclosure.

FIG. 3B illustrates an example polymer electrolyte including an ammonium-biphosphate (phosphonic acid) ion-pair coordinated side chain, in accordance with embodiments of the present disclosure.

FIG. 3C illustrates an example phosphonated polymer electrolyte, in accordance with embodiments of the present disclosure.

FIG. 4 is a graph illustrating conductivity of an ion-pair polymer and phosphonated polymer as a function of temperature under anhydrous conditions, in accordance with embodiments of the present disclosure.

FIG. 5 is a graph illustrating a thermogravimetric analysis (TGA) profile and exhaust Fourier-transform infrared (FTIR) analysis of a phosphonated polymer during a temperature scan in air, in accordance with embodiments of the present disclosure.

FIG. 6 is a graph illustrating PEMSE system performance at 160° C. using a biphosphate-quaternary ammonium (phosphoric acid) paired polyphenylene membrane system, in accordance with embodiments of the present disclosure. The anode included iridium(IV) oxide (IrO₂). The cathode included platinum ruthenium/carbon (PtRu/C). The gas-diffusion layer includes Pt-coated titanium (Ti).

FIG. 7 is a graph illustrating proton conductivity of the three side chains of FIGS. 3A-3C, as a function of relative humidity (RH), at 80° C., in accordance with embodiments of the present disclosure.

### DETAILED DESCRIPTION

Water electrolysis in combination with intermittent renewable energy sources is highly beneficial for clean energy. The present disclosure provides, among other things, water electrolysis systems that operate at intermediate temperature (i.e., between about 100° C. and about 300° C.). At least some aspects of the present disclosure relate to proton exchange membrane steam electrolysis (PEMSE) systems. In at least some examples, a water electrolysis system may include a stable acid-doped quaternary ammonium functionalized polymer or a phosphonic acid functionalized polymer. Such polymers have enhanced capability to retain acid phase even in the presence of high temperature steam exposure.

Some steam electrolyzers lack long-term stability because either the polymer electrolytes have low conductivity, or the polymer electrolytes lack stability in water. The water electrolysis system of the present disclosure exhibits relatively low cell resistance and significant water tolerance, making the water electrolysis system beneficial for such operating conditions. The water electrolysis system disclosed herein will substantially broaden the operating conditions of water electrolysis with enhanced performance and, therefore, reduce the cost of hydrogen production through water electrolysis. Other promising benefits of the herein disclosed water electrolysis system include the use of waste steam for direct feed, as well as a high tolerance of impurity for electrolyzer catalysts.

### Definitions

As used herein, an “alkane” refers to an acyclic saturated hydrocarbon. In other words, an alkane consists of hydrogen and carbon atoms in which all C—C bonds are single. An alkane may be a linear alkane. Example linear alkanes include methane, ethane, propane, butane, pentane, hexane, etc. An alkane may alternatively be a branched alkane. Example, branched alkanes include, but are not limited to, n-pentane, isopentane, and neopentane.

As used herein, an “alkene” refers to a hydrocarbon containing a C—C double bond. Example alkenes include propene, butene, pentene, hexene, etc. An alkene may be a cis isomer, meaning the two single C—C bonds adjacent to the C—C double bond are on the same side of a plane of the alkene. Conversely, an alkene may be a trans isomer, meaning the two single C—C bonds adjacent to the C—C double bond are on different sides of a plane of the alkene.

As used herein, a “cycloalkyl group” refers to a cycloalkane having a hydrogen atom removed therefrom. A cycloalkyl group is a univalent radical.

As used herein, an “aromatic group” refers to a planar unsaturated ring of atoms that is stabilized by an interaction of the bonds forming the ring. Example aromatic groups including benzene and its derivatives.

As used herein, a “heteroaryl group” refers to a group of atoms having both heterocyclic and aromatic properties.

As used herein, “heterocyclic” refers to a ring structure containing at least one non-carbon element [e.g., N, oxygen (O), sulfur (S)] in the ring.

As used herein, a “heterocycloalkyl group” refers to a non-aromatic monocyclic or polycyclic ring including carbon and hydrogen atoms and at least one heteroatom (e.g., N, O, S).

### Proton Exchange Membrane Steam Electrolysis (PEMSE) System

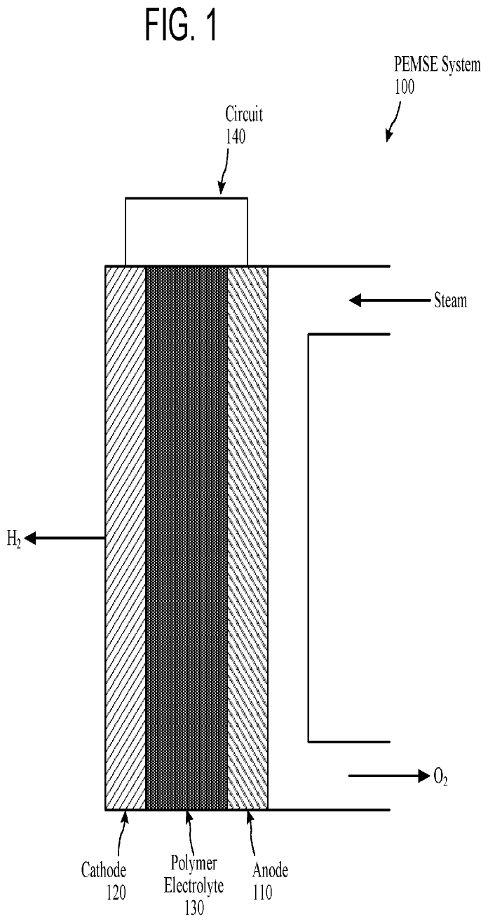

Aspects of the present disclosure relate to a proton exchange membrane steam electrolysis (PEMSE) system 100. As illustrated in FIG. 1, the PEMSE system 100 includes an anode 110 and a cathode 120. In PEMSE systems that use pure water, when electrical power is connected to the anode 110 and cathode 120, hydrogen cations (H⁺) are reduced at the cathode 120 to produce hydrogen gas (H₂), a component of hydrogen fuel, and hydroxide anions (OH⁻) are oxidized at the anode 110 to produce oxygen gas (O₂).

The anode 110 may include one or more metals. In at least some examples, the anode 110 may be an inert metal. Illustrative inert metals that may be included in the anode 110 include, but are not limited to, platinum (Pt), stainless steel [i.e., an iron (Fe) alloy with added elements such as chromium (Cr), nickel (Ni), silicon (Si), manganese (Mn), nitrogen (N), and carbon (C)], iridium (Ir), and alloys thereof.

The cathode 120 may include one or more metals. In at least some examples, the cathode 120 may be an inert metal. Illustrative inert metals that may be included in the cathode 120 include, but are not limited to, Pt, stainless steel, Ir, and alloys thereof.

In at least some examples, the anode 110 and the cathode 120 may include the same metal(s). In at least some other examples, the anode 110 and the cathode 120 may include one or more different metals.

The PEMSE system 100 includes a polymer electrolyte 130 located between the cathode 120 and the anode 110. Details of the polymer electrolyte 130 are provided herein below.

In operation, steam (H₂O) is oxidized at the anode 110 to produce oxygen gas (O₂), electrons, and protons (H⁺). The protons are transported across the polymer electrolyte 130 and reduced to hydrogen gas (H₂) at the cathode 120 using electrons transported from the anode 110 to the cathode 120 via an external circuit 140. In at least some embodiments, a porous metal mesh (e.g., porous titanium mess) may be positioned between the anode 110 and the steam channel to serve as a diffusion layer. In at least some embodiments, carbon paper may be used as a gas diffusion layer (GDL) placed between the cathode 120 a flow field of the hydrogen gas.

The PEMSE system 100 of the present disclosure offers kinetic and thermodynamic advantages compared to low-temperature water electrolysis. The elevated operating temperature of the PEMSE system 100 of the present disclosure improves the electrode kinetics for both the hydrogen evolution reaction at the cathode 120 and oxygen evolution reaction at the anode 110. As a result, the over-potential at both electrodes is reduced compared to low-temperature electrolysis systems. In addition, steam electrolysis is thermodynamically favorable; the reversible voltage of the water electrolysis cell is as low as 1.10 V at 250° C. compared to 1.23 V at room temperature. Therefore, electrical efficiency can be improved from 75% (80° C.) to 95% (250° C.). The advantages of a PEMSE system 100 of the present disclosure becomes apparent when compared to other water electrolysis methods, including alkaline electrolysis, low-temperature PEM electrolysis, and SOE, as represented in Table 1 below.

TABLE 1
Comparison of proton exchange membrane steam electrolysis (PEMSE) with other technologies.
Current and Anticipated Metrics

| Water | | | | Non-Balanced | | Electrical |
|---|---|---|---|---|---|---|
| Electrolysis | Electrolyte | Operating | | H₂ | Cost of | Efficiency |
| Technology | Conductivity | Temperature | Durability | Pressure | BOPs | (HHV H₂) |
| Alkaline | Low | Low | High (<10 | 200 psi | Low | Low |
| Electrolysis | (0.1 S/cm) | (<90° C.) | years, <3 | | | (70-80%) |
| | | | μV/h) | | | |
| Low T PEM | Low | Low | Intermediate | 5000 psi | High | Low |
| Electrolysis | (0.1 S/cm) | (<90° C.) | (>5 years) | | | (70-80%) |
| Solid Oxide | High | High | Low (<5 | 1000 psi | High | High |
| Electrolysis | (>0.2 S/cm) | (>700° C.) | years) | | | (>90%) |
| PEMSE | High | Intermediate | Intermediate | 5000 psi | Intermediate | High |
| | (>0.1 S/cm) | (100° C.- | (>5 years)* | | | (>90%) |
| | | 300° C.) | | | | |

*Estimated from molten carbonate fuel cell and alkaline electrolysis

In at least some examples, the polymer electrolyte 130 may operate at a temperature as low as about 100° C. and as high as about 300° C. Moreover, a PEMSE system 110 of the present disclosure may operate at 75% efficiency [from high heat value (HHV)] when the PEMSE system 100 is operated at about 80° C., and at 95% efficiency when the PEMSE system 100 is operated at about 250° C.

### Polymer Electrolytes

As described above, the PEMSE system 110 includes a polymer electrolyte 130 between the anode 110 and the cathode 120. The polymer electrolyte 130 is a substance that (i) includes a number of similar units bonded together (i.e., a polymer) and (ii) is capable of being decomposed by electrolysis to facilitate transfer of molecules between the anode 110 and the cathode 120. A polymer is a substance having a molecular structure consisting substantially (or entirely) of a significant number of repeating units (i.e., monomers) bonded together. Generally, a monomer may include a backbone and a side chain. Various backbone and side chain compositions of monomers of the polymer electrolyte 130 are discussed in detail below.

In at least some examples, the polymer electrolyte 130 may be an ionomer. As used herein, an “ionomer” refers to a class of polymers, including thermoplastic resins, stabilized by ionic cross-linkages. “Plastic” is a synthetic material made from various organic polymers such as polyethylene, polyvinyl chloride (PVC), nylon, etc. A “thermoplastic” is a material, such as a plastic polymer, that becomes softer when heated and harder when cooled.

### Polymer Electrolyte Backbones

The backbone of the polymer electrolyte 130 may include a variety of molecules. The backbone may include inorganic molecules [i.e., molecules not containing carbon (C)] and/or organic molecules (i.e., molecules containing C).

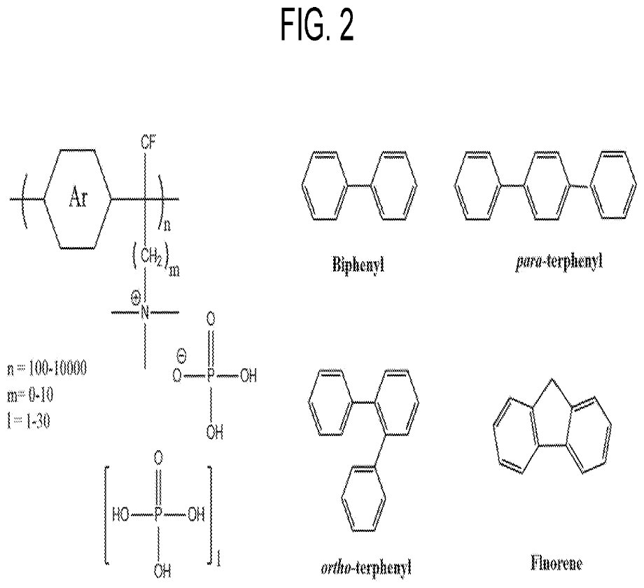

In at least some examples, the backbone may include one or more cyclic organic molecules. In at least some examples, the backbone may include one or more aromatic organic molecules. A non-limiting list of aromatic organic molecules that may be included in the backbone includes biphenyl, para-terphenyl, ortho-terphenyl, and fluorene. The chemical structures of these aromatic organic molecules are provided in FIG. 2.

In at least some examples, the backbone may include one or more poly(aryl) molecules. A poly(aryl) molecule is a molecule including more than one aromatic hydrocarbon that each has a hydrogen atom missing, resulting in each aromatic hydrocarbon being a radical (i.e., an aromatic hydrocarbon having an unpaired valence electron).

In at least some examples, the backbone may include one or more poly(aryl ether) molecules. A poly(aryl) ether molecule includes two or more aromatic hydrocarbons, where adjacent aromatic hydrocarbons are bonded via a —O— bond. Example poly(aryl ether) molecules include, but are not limited to, poly(aryl ether sulfone), poly(aryl ether ketone), and poly(aryl ether nitrile).

In situations where the backbone of the polymer electrolyte 130 includes one or more phenyl groups, the adsorption of the phenyl group(s) on oxygen evolution catalyst might oxidize over time. To minimize or negate this, oxidation affecting performance and durability of the PEMSE system 100, the chemical structure of the polymer electrolyte 130 may be altered to contain one or more phenyl groups with less adsorbing characteristics, such as polyfluorene, ortho-biphenylene, and the like.

### Polymer Electrolyte Side Chains

The polymer electrolyte 130 may be functionalized with a variety of side chains. In at least some examples, a side chain may include an acid. In at least some examples, the acid may include phosphorous. A non-limiting list of acids comprising phosphorous includes phosphinic acid, phosphonic acid, phosphoric acid, pyrophosphoric acid, triphosphoric acid, trimetaphosphoric acid, hypophosphoric acid, and isohypophosphoric acid. In at least some examples, inclusion of phosphorous-containing acid within a side chain may negate a risk of leaching of proton-conducting acid groups upon exposure of the polymer electrolyte 130 to high temperature steam. In at least some examples of the present disclosure, phosphonic acid may be covalently bonded in a polymer, thus having ultimate retention of the conductive phosphonic acid group under high water pressure and high-temperature conditions.

In at least some examples, a phosphorous atom of a side chain may be covalently bound to the backbone of the polymer electrolyte 130 through a C—P bond. In at least some other examples, a side chain may be bound to the backbone through a C—C bond. Examples of side chains that include phosphorous and that may be bound to the backbone through a C—C bond include, but are not limited to, side chains comprising phosphonic acid bound to an alkane, an alkene, a cycloalkyl group, an aryl group, an aromatic group, a heteroaryl group, a heterocycloalkyl group, or some other organic functionality. The leftmost chemical structure illustrated in FIG. 2 is an example of a monomer (of the polymer electrolyte 130) including a backbone (denoted “n”) covalently bond to a side chain through a C—C bond.

The polymer electrolyte 130 may, in at least some examples, be a phosphonated polyaromatic electrolyte, meaning a side chain of the polymer electrolyte 130 may include phosphorous and more than one aromatic group. Phosphonated polyaromatic electrolytes are able to efficiently conduct protons at a high humidity.

In at least some examples, a molecule (forming part of a side chain and which is placed between the backbone and a phosphorous atom of the side chain) may include one or more halogens (or include some other negatively charged atom or molecule) to enhance the acidity of the phosphorous atom and/or increase hydrophobicity of the side chain. The one or more halogens that may be covalently bound to the molecule may be individually selected to be fluorine (F), chlorine (Cl), bromine (Br), iodine (I), or astatine (At).

In at least some examples, the polymer electrolyte 130 may include an acid doped ammonium functionalized polymer, meaning the side chain of the polymer electrolyte 130 may include an ammonium group coordinated with an acid. A strong interaction between the ammonium group and the acid may enhance acid retention in the polymer electrolyte 130 in the presence of high-pressure water steam. A non-limiting list of ammonium functional groups that may be included in the side chain includes, but is not limited to, alkyl ammonium, imidazolium, phosphonium, guanidinium, sulfonium, piperidinium, pyridinium, pyrrolidinium or other cations. A non-limiting list of acids that may be coordinated with the ammonium function group includes, but is not limited to, disulfonic acid, phosphoric acid, diphosphonic acid, perfluorophosphonic acid, or other like acids.

In at least some examples, the polymer electrolyte 130 may be an acid doped quaternary ammonium functionalized polymer, meaning the side chain of the polymer electrolyte 130 may include a quaternary ammonium group (i.e., positively charged polyatomic ion of the structure NR⁺4, with R being independently selected to be an alkyl group or an aryl group) coordinated with an acid. The leftmost portion of FIG. 2 illustrates an example in which the side chain includes a quaternary ammonium group coordinated with phosphoric acid. However, it will be appreciated that the quaternary ammonium group of the side chain may be coordinated with other phosphorous containing acids, and other acids not including phosphorous. Ion-pair coordinated polyaromatic electrolytes are able to efficiently conduct protons under a range of humidity levels.

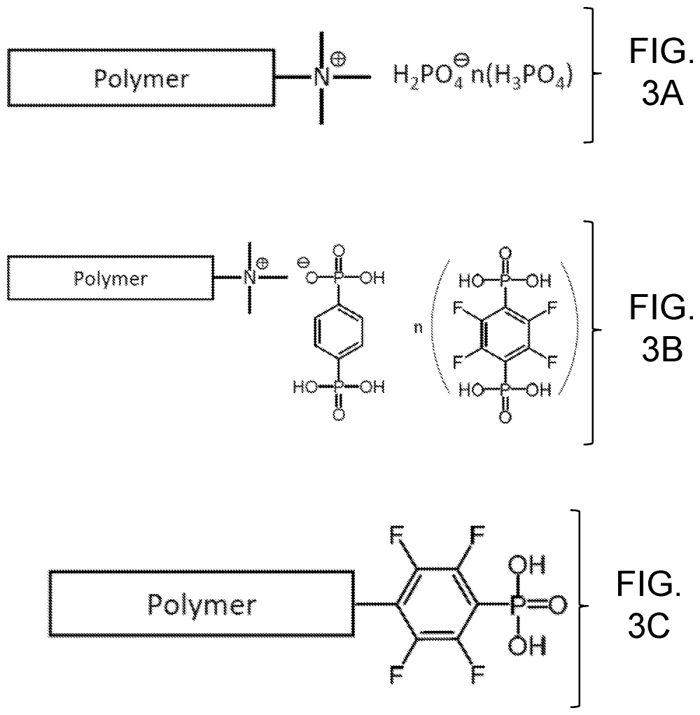

FIG. 3A illustrates an example polymer electrolyte including an ammonium-biphosphate (phosphoric acid) ion-pair coordinated side chain. FIG. 3B illustrates an example polymer electrolyte including an ammonium-biphosphate (phosphonic acid) ion-pair coordinated side chain. FIG. 3C illustrates an example polymer electrolyte including a phosphonated side chain.

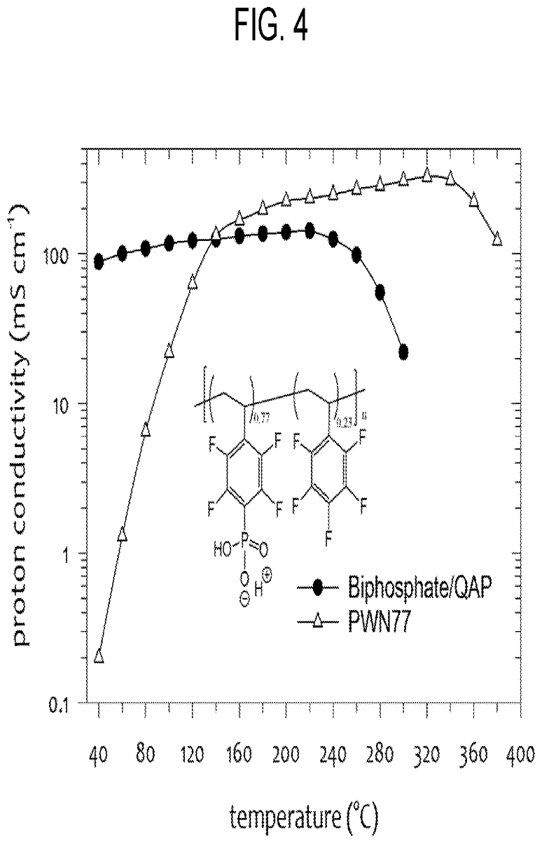

FIG. 4 shows the proton conductivity of the three types of phosphorous-containing polymers as a function of relative humidity. Note that all three types of polymers have high proton conductivity, ca.>10 mS/cm at 95% RH and 80° C., which is suitable for PEMSE applications.

For polymer electrolytes disclosed herein to be used in an electrode of a PEMSE system, the acidity and hydrophobicity of a functional group (e.g., a phosphonated functional group) may be enhanced. The acidity of phosphonic acid is lower than that of the sulfonic acid, which can reduce the hydrogen and oxygen evolution reaction activities of electrocatalysts. Unlike low-temperature electrolyzers, reactant water is supplied to catalysts (in a PEMSE system) in the form of water vapor that may require hydrophobicity of the electrode to remove H₂ and O₂ products from the electrode. In examples where the polymer electrolyte is functionalized with phosphonic acid, the polymer electrolyte may be halogenated (or include some other negatively charged atom or molecule) to enhance the acidity of the phosphonic acid and increase hydrophobicity.

It may be beneficial for the acidity and/or hydrophobicity of a functional group (e.g., a phosphonated functional group) to be enhanced. The acidity of phosphonic acid is lower than that of the sulfonic acid, which can reduce the hydrogen and oxygen evolution reaction activities of electrocatalysts. Unlike low-temperature electrolyzers, reactant water is supplied to catalysts (in a PEMSE system) in the form of water vapor (or steam) that may benefit from hydrophobicity of the electrode to remove H₂ and O₂ products from the electrode. In examples where the polymer electrolyte 130 is functionalized with phosphonic acid, the polymer electrolyte 130 may be halogenated (or comprise some other negatively charged atom or molecule) to enhance the acidity of the phosphonic acid and increase hydrophobicity.

In at least some embodiments, the polymer electrolyte may be phosphonated poly(pentafluorostyrene) (referred to as PWN77 herein). PWN77 includes repeating units of a first styrene monomer and a second styrene monomer. The first styrene monomer includes benzene functionalized with fluorine at all carbons except the carbon attached to the backbone and the para-carbon. The para-carbon is functionalized with phosphonic acid. The second styrene monomer includes benzene functionalized with fluorine at all carbons except the carbon attached to the backbone.

### Methods of Making a Polymer Electrolyte

### Synthesis of Ion-Pair (Biphosphate-Ammonium) Membrane

The ion-pair (biphosphate-ammonium) was synthesized by an irreversible Diels-Alder reaction between tetramethylbis(cyclopentadienone) and 1,4-diethynylbenzene. This polymer was then brominated, converting a fraction of the methyl positions into bromomethyl groups. The resultant functionalized polymer was then cast into films from chloroform. The films were then soaked in a 5 M solution of aqueous trimethyl amine to generate the quaternary ammonium functionalized membranes. The membranes were then immersed in an 85 wt % aqueous solution of phosphoric acid at room temperature for 2 hr. All phosphoric acid-doped quaternary ammonium functionalized polymer were used after removing the excess phosphoric acid on the membrane surface by blot drying.

### Synthesis of Phosphonated Polymer Membrane

The phosphonated polymer (PWN77) was synthesized by dispersing polypentafluorostyrene (PFS, 100 g, 515 mmol monomer units, Mw=200 kDA, PDI=3.4) in dimethylacetamide, DMAc (400 ml) and tris(trimethylsilsyl)phosphite, TMSP (200 g, 670 mmol) was added slowly. The reaction solution was then heated to 160° C. and magnetically stirred overnight. After the reaction was completed, the warm mixture was precipitated in 2 L water and collected via filtration. The resulting white powder was refluxed in water three times for 30 min each, exchanging water each time, followed by boiling in a 2 wt % phosphoric acid solution. Washing with water until neutral and drying at 140° C. yielded 130 g (a 99% yield) of the phosphonated polymer with 70% degree of phosphonation, PWN77.

### EXAMPLES

To assess the feasibility of using a phosphonated polymer electrolyte versus an ion-pair membrane, the proton conductivity of a model phosphonated polymer (PWN77) over a wide range of temperatures was measured. As illustrated in FIG. 4, the conductivity of a phosphonated polymer electrolyte (triangles) is lower than that of an ion-pair membrane (circles) below 120° C. However, above 120° C., the proton conductivity is equivalent or even higher than that of an ion-pair membrane. The high conductivity remains up to 330° C.

As described herein, in at least some examples, a polymer electrolyte of the present disclosure may have a backbone based on chemically stable engineering plastic. Polymer electrolytes of the present disclosure, having such backbones, demonstrate significant chemical stability over a wide pH range (0-14).

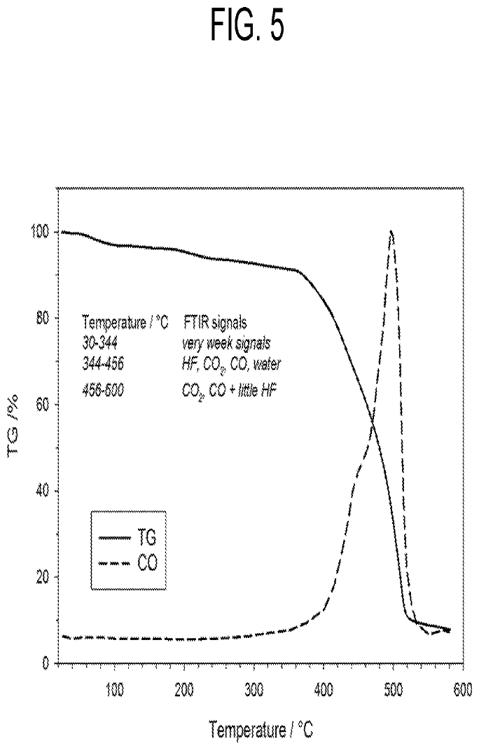

In at least some examples, a phosphonated group is linked to a side chain through a C—P bond, which is hydrolytically stable. In such examples, the thermal degradation temperature was over 400° C., as seen from thermogravimetric analysis (TGA). As shown in FIG. 5, the polymer electrolyte is stable until thermal decomposition occurs around 450° C. It will be appreciated that the chemical stability can be enhanced by varying the backbone and/or functional group, molecular weight, and processing conditions to manipulate the membrane crystallinity.

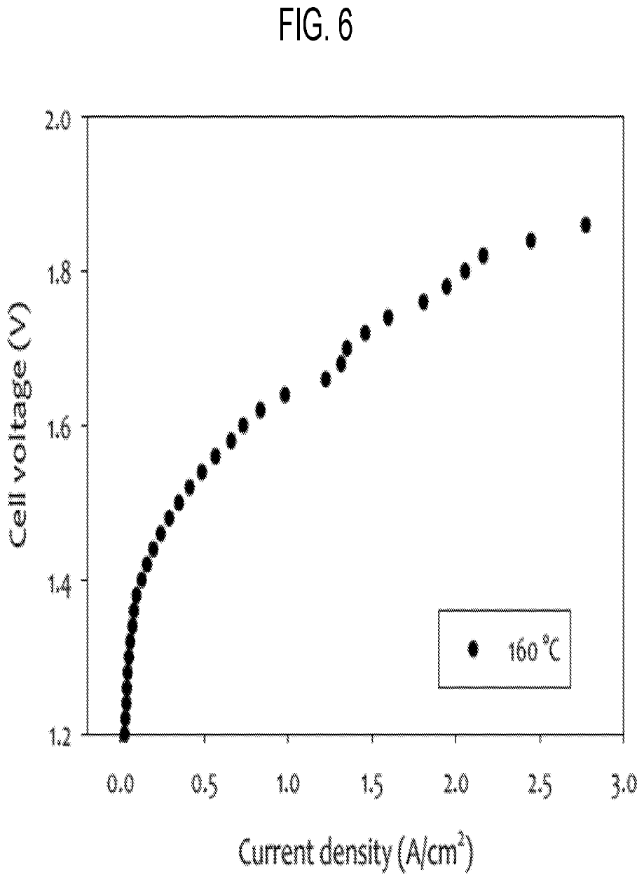

A steam electrolysis cell demonstrated promising performance at 160° C. (FIG. 6). This test used un-optimized and non-reinforced ion-pair (biphosphate-ammonium) membrane, phosphonated ionomer, and commercial IrO₂ catalyst. The PEMSE system's performance was significant, with low onset voltage (1.3 V) and a current density of 2.5 A/cm2 at 1.8 V. The high frequency resistance (HFR) of the cell was 0.07 Ω/cm². The calculated membrane conductivity was 100 mS/cm, which is consistent with the high conductivity of the membrane shown in FIG. 5.

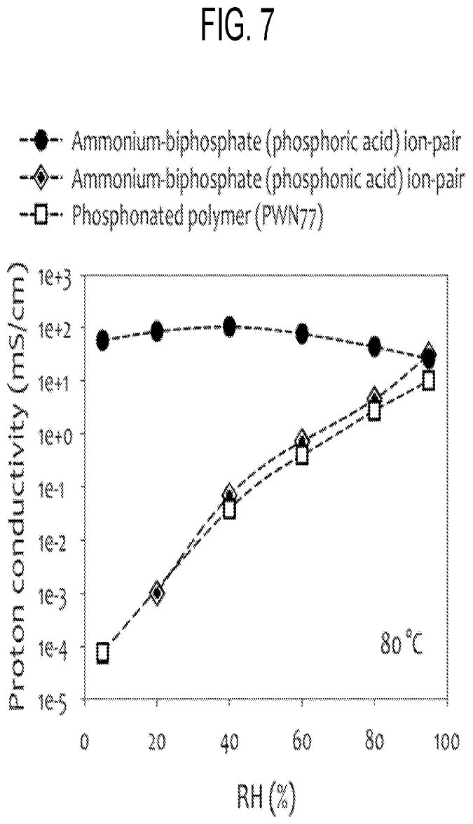

FIG. 7 is a graph illustrating proton conductivity of the three side chains of FIGS. 3A-3C, as a function of relative humidity (RH), at 80° C., in accordance with embodiments of the present disclosure. As shown in FIG. 7, the proton conductivity of the side chains increases (or remains high) as RH is increased.

### Overview of Terms and Abbreviations

The following explanations of terms are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting, unless otherwise indicated. Other features of the disclosure are apparent from the foregoing detailed description and the claims.

Unless otherwise indicated, all numbers expressing quantities of components, molecular weights, percentages, temperatures, times, and so forth, as used in the specification or claims, are to be understood as being modified by the term “about.” Accordingly, unless otherwise indicated, implicitly or explicitly, the numerical parameters set forth are approximations that can depend on the desired properties sought and/or limits of detection under standard test conditions/methods. While the present disclosure has been particularly described in conjunction with specific embodiments, it is evident that many alternatives, modifications, and variations will be apparent to those skilled in the art in light of the foregoing description. It is therefore contemplated that the appended claims will embrace any such alternatives, modifications, and variations as falling within the true spirit and scope of the present disclosure.

What is claimed is:

1. A method comprising:
contacting a steam feed with an anode of a steam electrolyzer that includes the anode, a cathode, and a polymer electrolyte located between the anode and the cathode, wherein the polymer electrolyte includes a repeating plurality of styrene monomers; and
operating the steam electrolyzer between about 100° C. and about 300° C. thereby producing H₂ gas and O₂ gas from the steam feed.

2. The method of claim 1, wherein hydrogen cations (H⁺) are reduced at the cathode to produce the H₂ gas, and hydroxide anions (OH⁻) are oxidized at the anode to produce the O₂ gas.

3. The method of claim 1, wherein the anode comprises iridium.

4. The method of claim 3, wherein the steam electrolyzer further comprises a steam channel for the steam feed, and a porous titanium mesh positioned between the anode and the steam channel.

5. The method of claim 1, wherein the polymer electrolyte comprises phosphonated poly(pentafluorostyrene).

6. The method of claim 5, wherein the phosphonated poly(pentafluorostyrene) comprising a polymer backbone that includes (i) a first styrene monomer that includes benzene functionalized with fluorine at all carbons except the carbon attached to the polymer backbone and the para-carbon, wherein the para-carbon is functionalized with phosphonic acid, and (ii) a second styrene monomer includes benzene functionalized with fluorine at all carbons except the carbon attached to the polymer backbone.

7. The method of claim 3, wherein the polymer electrolyte comprises phosphonated poly(pentafluorostyrene).

8. A method comprising:
contacting a steam feed with an anode of a steam electrolyzer that includes the anode, a cathode, and a polymer electrolyte located between the anode and the cathode, wherein the polymer electrolyte comprises a stable acid-doped quaternary ammonium functionalized polymer or a phosphonic acid functionalized polymer, and the anode comprises iridium; and
operating the steam electrolyzer between about 100° C. and about 300° C. thereby reducing hydrogen cations (H⁺) at the cathode to produce H₂ gas, and oxidizing hydroxide anions (OH⁻) at the anode to produce O₂ gas.

9. A system comprising:
a steam electrolyzer that includes an anode, a cathode, and a polymer electrolyte located between the anode and the cathode, wherein the polymer electrolyte includes a repeating plurality of styrene monomers; and
a steam source fluidly coupled to the anode of the steam electrolyzer.

10. The system of claim 9, wherein the anode comprises iridium.

11. The system of claim 10, wherein the steam electrolyzer further comprises a steam channel for the steam feed, and a porous titanium mesh positioned between the anode and the steam channel.

12. The system of claim 9, wherein the polymer electrolyte comprises phosphonated poly(pentafluorostyrene).

13. The system of claim 12, wherein the phosphonated poly(pentafluorostyrene) comprising a polymer backbone that includes (i) a first styrene monomer that includes benzene functionalized with fluorine at all carbons except the carbon attached to the polymer backbone and the para-carbon, wherein the para-carbon is functionalized with phosphonic acid, and (ii) a second styrene monomer includes benzene functionalized with fluorine at all carbons except the carbon attached to the polymer backbone.

14. The system of claim 10, wherein the polymer electrolyte comprises phosphonated poly(pentafluorostyrene).

15. A system comprising:
a steam electrolyzer that includes an anode, a cathode, and a polymer electrolyte located between the anode and the cathode, wherein the polymer electrolyte comprises a stable acid-doped quaternary ammonium functionalized polymer or a phosphonic acid functionalized polymer, and the anode comprises iridium; and
a steam source fluidly coupled to the anode of the steam electrolyzer.
